(19) United States
(12) Patent Application Publication
(10) Pub. No.: US 2014/0311970 A1
(43) Pub. Date: Oct. 23, 2014

(54) ROTATING DRUM MICRO-SCREEN FOR PRIMARY WASTEWATER TREATMENT

(71) Applicant: ANAERGIA INC., Burlington (CA)

(72) Inventors: Michael David Theodoulou, Milton (CA); Juan Carlos Josse, Mission Viejo, CA (US)

(21) Appl. No.: 14/363,420

(22) PCT Filed: Dec. 4, 2012
(86) PCT No.: PCT/CA2012/050872

§ 371 Date: Jun. 6, 2014

Related U.S. Application Data
(60) Provisional application No. 61/568,463, filed on Dec. 8, 2011.

(51) Int. Cl. C02F 3/12; C02F 3/30; C02F 1/52; B01D 33/06; B01D 33/48

(52) U.S. Cl. CPC C02F 3/12; B01D 33/06; B01D 33/48; C02F 1/52; C02F 3/30
USPC 210/605; 210/402; 210/391; 210/396; 210/97; 210/106; 210/143; 210/784; 210/723; 210/631

(57) ABSTRACT

A rotating screen has one or more panels arranged into a cylinder, or drum. The panels have openings in a micro-screening range, for example 100 microns or less. Wastewater to be screened is fed to the interior of the drum. The drum rotates constantly but the rotation may be discontinuous and the speed of rotation may be variable. The drum may be cleaned by an air knife. If the wastewater contains oil and grease, a short hot water spray may be provided before cleaning with the air knife. Optionally, an internal auger conveys solids down the length of the drum to an outlet. The rotating screen may be used for primary treatment of wastewater. The rotating screen may be used produce screenings with a dried solids concentration of 5% or more, for example 6-7%. The primary sludge may be treated in an anaerobic digester.

### RELATED APPLICATIONS

This application claims the benefit of U.S. provisional application No. 61/568,463 filed on Dec. 8, 2011. U.S. provisional application No. 61/568,463 is incorporated by reference.

### FIELD

This specification relates to primary wastewater treatment, to water screening and to a rotating drum screening device.

### BACKGROUND

Many municipal wastewater treatment plants treat sewage using an activated sludge process. In the activated sludge process, the wastewater is treated through a series of process steps. In general, the process steps include pre-treatment, primary treatment and secondary treatment. The pre-treatment step may involve coarse screening or hydrocyclones, or both, and removes large inorganic solids such as sand and grit. The primary treatment step most often involves a clarifier and produces a primary sludge and clarified wastewater. The secondary treatment step treats the clarified wastewater by one or more biological processes and produces mixed liquor. The mixed liquor is separated, for example by another clarifier or a membrane system, into the final plant effluent and activated sludge. A portion of the activated sludge is recycled to the primary treatment step.

A typical activated sludge process, as described above, generates two waste streams. One waste stream is the primary sludge from the primary treatment step. The second waste stream is the remainder of the activated sludge, which is called waste activated sludge (WAS). These waste streams may be dried to a cake and landfilled, treated for use as biosolids or compost, or sent to an anaerobic digester. If an anaerobic digester is used, the WAS may be thickened to about 2-4% dried solids (DS) before being sent to the anaerobic digester. The primary sludge may already have a 2-4% DS concentration, and may be sent directly to the anaerobic digester.

Various alternatives to the activated sludge process are also in use. For example, primary treatment is sometimes used alone in locations where the discharge regulations can be met without secondary treatment.

### INTRODUCTION TO THE INVENTION

The following introduction is intended to introduce the reader to the detailed description to follow and not to limit or define any claimed invention. Claimed inventions may reside in a sub-combination of only some of the process steps or apparatus elements described in this introduction, or in a combination involving steps or elements described in other parts of this specification.

This specification describes a rotating screen. The rotating screen has one or more panels arranged into a cylinder, alternatively called a drum. The panels have openings in a micro-screening range, for example 100 microns or less, or 20-60 microns. Wastewater to be screened is fed to the interior of the drum. The drum may be partially immersed in screened wastewater. The drum rotates constantly so that the entire screening surface is involved in separation. However, the rotation may be discontinuous. Preferably, the average speed of rotation is variable. For example, the speed of rotation may be related to the depth of the wastewater in the drum. Optionally, the rotation regime may be chosen to leave a layer of solids on the screen.

The drum may be cleaned by an air sprayer, alternatively called an air knife. The air knife may be located outside of the drum and blow through the screen. Alternatively, the air knife may be located inside of the drum and blow air at the inside of the screen. The air knife may extend along the length of the drum, or travel across the length of the drum. Optionally, the air knife may be configured to leave a layer of solids on the screen. If the wastewater contains oil and grease, or when the screen is fouled, a water spray may be provided before cleaning with the air knife. To minimize the use of treated water and dilution of the primary sludge, the water is heated and the spray is provided only for brief periods of time.

An optional internal auger may convey solids down the length of the drum to an outlet. Optionally, the auger may leave a desired layer of solids on the screen surface.

The rotating screen may be used, for example, for primary treatment of wastewater. The rotating screen may produce screenings with a dried solids concentration of 5% or more, for example 6-7%. Chemicals, such as a coagulant or flocculant, may be used to enhance solids removal if required, but might not be required in all applications. The rotating screen provides a significant reduction in the biological oxygen demand (BOD), chemical oxygen demand (COD) and the total suspended solids (TSS) concentration of the wastewater. The rotating screen may be used alone or in combination with secondary treatment, for example in place of the primary clarifier in an activated sludge process. The primary sludge may be treated in a high solids anaerobic digester as described in U.S. provisional application 61/524,590, which is incorporated by reference. The rotating screen may also be used in treatment processes as described in International Application PCT/CA2011/050498, which is incorporated by reference, or other process in which enhanced primary treatment is used to provide a high solids primary sludge for anaerobic digestion and the primary effluent is treated with a low energy secondary process.

### BRIEF DESCRIPTION OF FIGURES

FIG. 1 is a schematic isometric view of a drum microscreen.

FIG. 2 is a schematic drawing of an alternative liquid wash system.

FIG. 3 is a schematic drawing of another alternative liquid wash system.

FIG. 4 is a schematic isometric view of the drum microscreen of FIG. 1 with an air knife in an alternative location.

FIG. 5 is a schematic partially cut away side view of an alternative drum microscreen.

### DETAILED DESCRIPTION

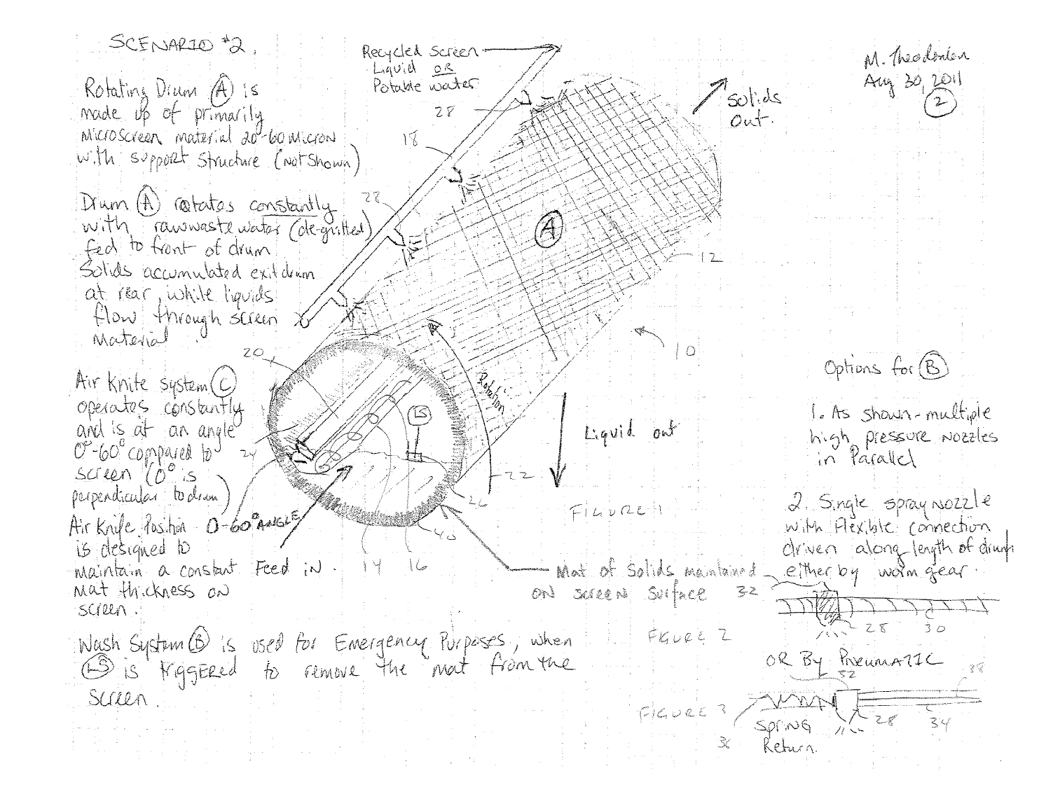

FIG. 1 shows a drum screen 10 having a frame (not shown) covered by a screening media 12. The frame may be made of stainless steel. The frame is attached to a central shaft which may be connected to a motor to rotate the drum screen 10. The shaft also supports and locates the drum screen 10 in a tank. The screening media 12 is made of a micro-screening material such as a polyester fabric or a stainless steel mesh. The screening media 12 has openings with a size of 100 microns or less, for example 20 to 60 microns. The opening size can be measured by the size of a sphere that is excluded by the mesh. For example, a 100 micron opening admits a sphere having a diameter of 100 microns or less but excludes a sphere having a diameter of over 100 microns. The walls of the tank form a seal against a lower part of the ends of the drum screen 10, or the ends of the drum screen 10 may have non-porous annular end plates. Water to be screened flows into the drum screen 10. Screened water passes through the screening media and is collected in that tank until it leaves, for example by flowing over a weir. A sludge containing retained solids collects in a backwash trough 14 and is removed by an auger 16. Drum screens as described in this paragraph (though not as otherwise shown in FIG. 1) are commercially available, for example from PR Aqua, Hydrotech and Atlantech.

In commercially available drum screens as described above, a water sprayer 18 is used to spray potable water or screened water through the screening media 12. The sprayed water blows retained sludge and solids from the inside surface of the screening media 12 and into the backwash trough 14. The resulting sludge has a solids content of about 1% on a total solids (TS) or dried solids (DS) basis. While this is adequate for many purposes, the drum screen 10 of FIG. 1 is intended to provide primary treatment according to the treatments systems described in U.S. provisional application 61/524,590 and International Application PCT/CA2011/050498. In these processes, primary sludge is treated in anaerobic digesters operating at high solids contents. Accordingly, it is desirable for the primary sludge to have a high solids content. The drum screen 10 may be operated to produce primary sludge with a solids content of 5% DS or more when treating typical municipal wastewater.

Optionally, the raw wastewater may be may pre-treated before it enters the drum screen 10. For example, the raw wastewater may pass through a pre-screen, for example a 3 mm coarse, and be de-gritted, using equipment typically found in municipal sewage plants upstream of a primary clarifier.

In the drum screen 10, retained solids (or screenings) are removed from the screening surface 12 primarily by way of an air sprayer 20, alternatively called an air knife. The air sprayer 20 may be in the form of stationary knife traversing the length of the drum screen 10 as shown, or in other forms such as a moving or stationary spiral along the length drum screen 10, or a set of discontinuous air sprayers. The air sprayer 20 is set at an angle of between about 0 and 60 degrees from perpendicular to the drum screen 10. When the drum screen 10 is rotated, for example in direction of rotation 22, solids packed against the inside surface of the screening medium 12 are brought into contact with air jets 24 from the air sprayer 20. The air jets 24 knock the solids from the screening medium 12, which allows the solids to fall into the backwash trough 14 for removal as a sludge by auger 16. Optionally, the solids may fall to the bottom of the drum screen 10 to be removed by a larger auger, as will be described further below. The proximity of the air sprayer 20 to the screening medium 12, the pressure of the air, and the angle of the air jets 24 are chosen to remove sufficient solids from the screening medium to keep water flowing by gravity (static head differential) through the screening medium 12. However, because water is not used to remove the solids from the screening surfaces 12, the solids content of the sludge is higher. The solids content may be 5% TS or more, for example 6 to 7% TS.

A water sprayer 18 may also be provided, particularly if an air sprayer 20 is retrofit to an existing drum screen with an existing water backwash system. The water sprayer 18 sprays potable water or screened water against the outside of the screening medium 12, which dislodges solids caught against the screening medium. However, the water sprayer 18 is not used as the primary backwashing device. Instead, the water sprayer 18 may be used as a backup system to remove solids when the air sprayer 20 fails, or as a peaking system to supplement the capacity of the air sprayer 20 during very high flow periods. The water used in the water sprayer 18 may be ambient temperature or heated, for example to 80C. Heated water in particular may be used to remove fats, grease or oils (FOG) that may accumulate on the screening surface 12 over time. When a FOG deposit builds up, heated water sprayed at the FOG deposit before the FOG deposit passes by the air sprayer 20 assists the air sprayer 20 in removing the deposit. The water sprayer 18 is placed slightly upstream, for example by 90 degrees or less, of the air sprayer 20 so that the FOG deposit may still be warm and moist when it passes by the air sprayer 20. The water sprayer 18 may be turned on at pre-set intervals for a pre-set period of time, these periods of time occurring while the drum screen 10 is turning. Alternatively, the water sprayer 18 may be turned on when a level sensor 26 indicates that the water inside the drum screen 10 has reached a pre-determined level that indicates that head los through the screen is at or near a design maximum.

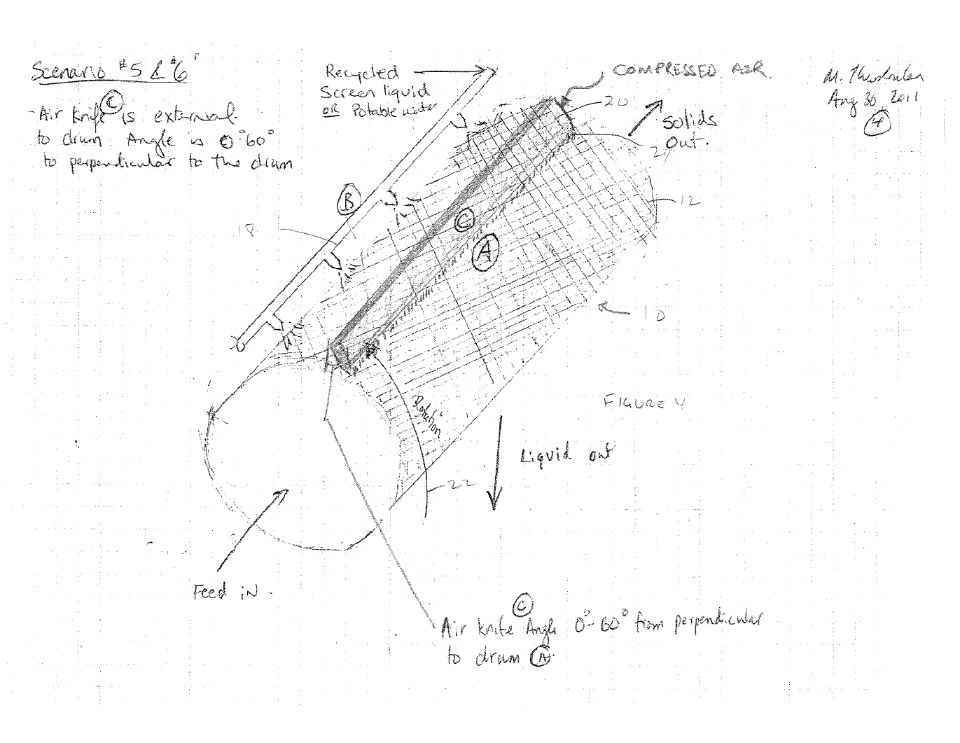

The water sprayer 18 has several nozzles 28 spaced along the length of the drum screen 10. The number of nozzles 28 shown in FIG. 1 is less than what would ordinarily be provided to simplify the drawing. Alternatively, as shown in FIG. 2, one or more nozzles 28 may be connected to a flexible water supply hose 32 and provided on a worm gear 30. Rotating the worm gear 30 causes the nozzle 28 to move back and forth across the length of the drum screen 10. FIG. 3 shows another alternative in which a nozzle 28 is driven back and forth along a smooth shaft 34. For example, the nozzle 28 may be driven in one direction by a spring 36 and in the other direction by a pneumatic cylinder 38.

Optionally, the rotation of the drum screen and the location and operation of the air sprayer 20 may be chosen such that a solids mat 40 is maintained on the inside of the screening medium 12 at an appreciable thickness. The solids mat 40 may reduce the effective size of the openings in the screening medium, provide a form of depth filtration or retain particles by adsorption or other forces, thus increasing the COD and SS removal of the drum screen 10. In general, the size of the mat 40 increases up to a point with increase in the average speed of rotation of the drum screen 10 and as the air sprayer 20 is moved away from the screening medium 12 or its air flow rate or pressure are reduced. Changing the angle of the air sprayer 20 may also effect the thickness of the mat 40. When the mat 40 is intentionally allowed to maintain some thickness, the water sprayer 18 is used only rarely when the level sensor 26 indicates an excessive depth of water in the drum screen 10. When the level sensor 26 is triggered, the water sprayer 18 is turned on to remove the solids mat 40 from the screening medium 12.

The drum screen 10 may rotate constantly, either by rotating continuously over an extended period of time, or by operating according to a repeated cycle over an extended period of time. If the drum screen 10 rotates continuously, it may rotate at a variable speed or at one of a set of pre-selected speeds. If the drum rotates according to a repeated cycle, the speed of rotation, duration of rotation and interval between successive periods of rotation may be pre-determined and programmed into a controller connected to a motor that rotates the drum screen 10. The average speed of rotation may increase with the water level inside of the drum screen 10. However, if the level sensor 26 is triggered (it senses a water depth above a pre-selected threshold) then the drum will start rotating, ignoring the pre-set interval between successive cycles, and rotate for its pre-set duration. The controller also allows the air sprayer 20 and water sprayer 18 to turn on only while the drum screen 10 is turning. The on and off times or operational cycles of the air sprayer 20 and the water sprayer 18 may also be pre-determined and programmed into the controller. However, the controller may also be programmed to turn one or both sprayers 18, 20 on despite their pre-determined operational cycles if the level sensor 26 is triggered. Alternatively, the air sprayer 20 may also be set up to turn on whenever the drum screen 10 is rotating and to turn off whenever the drum screen 10 is stopped. The constant rotation of the drum screen 10 assists in having all parts of the screening medium participate equally in screening.

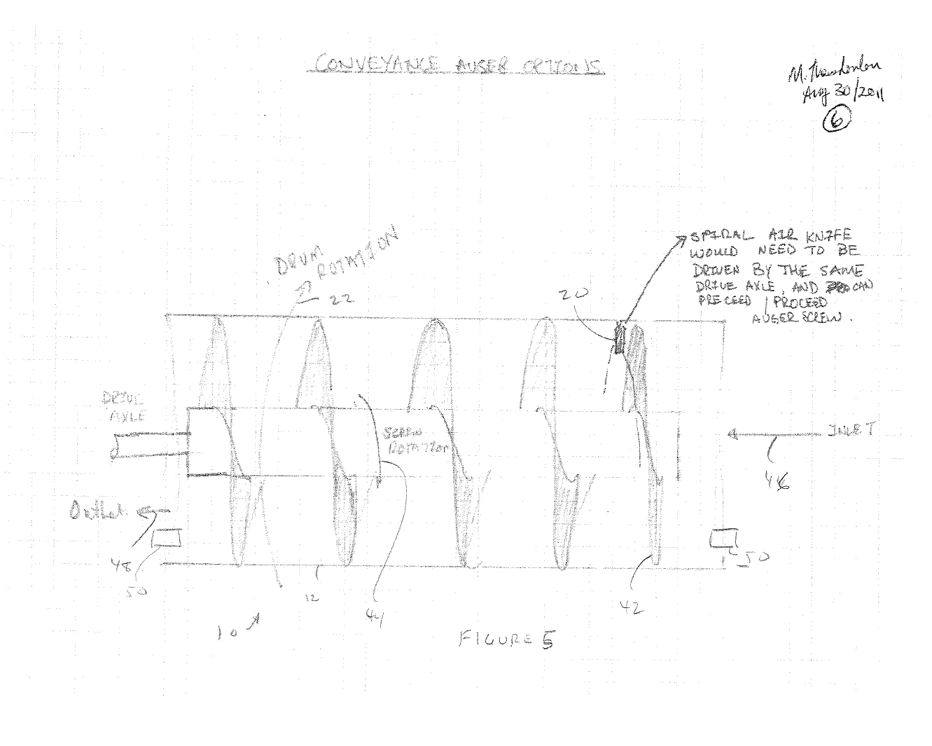

Referring to FIG. 4, the air sprayer 20 can alternatively be located on the outside of the drum screen 10. In this case, the air jets 24 again cover the length of the screening medium 12, but the air is blown through the screening medium 12. The air sprayer 20 may be oriented at from 0 to 60 degrees to perpendicular to the drum screen 10. Preferably, the air sprayer 20 is set at an angle such that the air jets 24 blow against the direction of rotation 22. An air sprayer 20 on the outside of the drum screen 10 can be straight as shown or it may spiral around the drum screen 10. Preferably, the water sprayer 18 is in front of the air sprayer 20 relative to the direction of rotation 22 rather than being behind the air sprayer 20 as shown in FIG. 4.

Referring to FIG. 5, the backwash trough 14 and auger 16 may be replaced with a larger drum auger 42. The outside edges of the drum auger 42 may touch the inside of the screening medium 12. Alternatively, a gap may be provided between the outside of the drum auger 42 and the screening medium 12 to allow a solids mat 40 to form to the size of the gap. The drum auger 42 rotates in an auger direction 44 which is opposite to the drum rotation direction 22. The drum auger 42 pushes retained solids from an inlet 46 where wastewater enters the drum screen 10 to an outlet 48 at the other end of the drum screen 10. An air sprayer 20 may be provided on the outside of the drum screen as shown in FIG. 4. Alternatively, a spiral air sprayer 20 may be provided inside of the drum screen and rotate with the drum auger 42. The air sprayer 20 may be attached to the blades or the shaft of the drum auger 42. The air sprayer 20 is preferably located on the outlet side of the auger blades such that the air sprayer 20 precedes the auger blade. A rotating air sprayer 10 may be angled to push solids towards the outlet 48. The drum auger 42 and drum screen 10 may be driven on concentric shafts. Alternatively, the drum screen 10 may be supported on, and turned by, two or more rollers 50 on its inner or outer diameter at both of its ends. In this case, the drum auger 42 shaft may be supported on the frame of the drum screen 10.

The drum auger 42 may rotate continuously or periodically, either as defined by a pre-set operational cycle or when triggered to start rotating by a signal from the level sensor 26. Solids reaching the outlet 48 are pushed into a hopper at the end of the drum screen 10 or removed from the drum screen by a sludge pump. The water level in a tank around the drum screen 10 is preferably kept low, optionally below the bottom of the drum screen 10.

The drum screen 10 may be used to provide primary wastewater treatment. In that use, the drum screen 10 may replace a conventional clarifier in a municipal wastewater treatment plant, for example an activated sludge plant. The drum screen 10 may also be used when only primary treatment is provided. Optionally, if very high removal rates of suspended solids (SS), biological oxygen demand (BOD) and chemical oxygen demand (COD) are desired, the wastewater can be treated with coagulant or flocculant chemicals before it enters the drum screen 10. For example, a metal salt such as alum or ferric chloride can be mixed into the wastewater along with a polymeric flocculant. However, over 50% of the SS and 50% of the COD may be removed from raw wastewater even without any added chemicals.

Coagulation and flocculation chemicals can be added in or before the front end of the screen to maximize colloidal matter and suspended solids removal and enable small particles to grow through flocculation such that less blinding of the screen occurs. The micro screen can then be operated at higher hydraulic loading rates with reduced screen washing frequency.

Polymeric coagulants or flocculants, used either alone, in combinations of polymers, or in combination with metal salts such as alum or ferric chloride, are ideal to create flocs but the polymer is expensive. Alternatively, exocelular polymer substances (EPS) can be used in place of synthetic polymers. EPS is produced naturally by the activated sludge bacteria and can be used to enhance flocculation in a step upstream of the micro screen. This can be done by returning a small amount of WAS or mixed liquor (ML) from an activated sludge tank to a mechanical, fine bubble air-induced or hydrodynamic flocculation unit upstream of the screen where a low G (energy gradient 20 to 30 s-1) is introduced to help in the formation of flocs helped by the EPS brought with the WAS or ML.

In some applications, the air knife is not required to clean the screen. Water cleaning can be used in some applications instead particularly if it is done with high pressure small volume nozzles using recirculated filtered water out of the micro screen. The air knife allows a 6 or 7% solids screenings stream to be produced for feeding without at high solids without further thickening to a digester. Producing such high solids screenings also requires a mechanical auger inside the drum screen to convey the thick screenings stream out of the drum. However, washing the screen with high pressure water is acceptable when a 2 or 3% solids screenings stream is desired. Such a stream can be conveyed out of the drum with an inclined trough without using a motor driven auger. When recuperative thickening is used with the digesters, particularly as described in U.S. provisional application 61/524,590 and International Application PCT/CA2011/050498, feeding lower solids content to the digester may still be acceptable.

Optionally, the drum can rotate constantly and continuously with cleaning triggered by water level in the drum.

1. A screen comprising,
a) a rotating drum comprising a screening media;
b) a compressed air sprayer located to spray air through the screening media or at an inner surface of the screening media.

2. The screen of claim 1 further comprising a water sprayer located to spray water through the screening media.

3. The screen of claim 2 further comprising a motor to rotate the screen wherein the water sprayer is located ahead of the compressed air sprayer in a direction of rotation by 90 degrees or less.

4. The screen of claim 2 further comprising a heater to heat water before it leaves the water sprayer.

5. The screen of claim 1 further comprising a backwash trough positioned near the compressed air sprayer.

6. The screen of claim 1 further comprising an auger to moved retained solids out from the interior of the screen.

7. The screen of claim 6 wherein an outer surface of the auger contacts an inner surface of the screen.

8. The screen of claim 1 further comprising a motor to rotate the screen, a controller, and a water level sensor in communication with the inside of the screen, wherein the controller is configured to increase the average speed of rotation of the screen when the sensor senses an increase in water level.

9. The screen of claim 1 further comprising a water sprayer, wherein the controller is configured to operate the water sprayer when the sensor senses a pre-determined water level.

10. The screen of claim 1 further comprising a motor to rotate the screen and a controller wherein the controller causes the motor to rotate the screen continuously or intermittently according to a pre-determined speed or cycle.

11. The screen of claim 10 wherein the controller is configured to turn on the air sprayer only when the screen is rotating.

12. The screen of claim 1 wherein the screening media has openings having a size and shape that would exclude a sphere of larger than 100 microns in diameter.

13. A screening process comprising the steps of,
a) flowing water to be screened into the interior of a drum comprising a screening media;
b) rotating the drum; and,
c) spraying air through or against the screening media to remove retained solids from the screening media.

14. The process of claim 13 further comprising removing retained solids from the inside of the drum.

15. The process of claim 13 further comprising a step of spraying heated water through or against the screening media.

16. A primary wastewater treatment process comprising the steps of,
a) flowing wastewater into the interior of a drum comprising a screening media;
b) rotating the drum;
c) spraying air through or against the screening media to remove sludge containing retained solids from the screening media; and,
d) removing retained solids from the inside of the drum.

17. The process of claim 16 wherein the screening media has openings having a size and shape that would exclude a sphere of larger than 100 microns in diameter.

18. The process of claim 16 further comprising adding a metal salt and a polymer, or a metal salt and activated sludge or mixed liquor, to the wastewater.

19. The process of claim 16 wherein the sludge has a dried solids content of 5% or more.

20. The process of claim 19 wherein further comprising treating the sludge in an anaerobic digester.

21. (canceled)
